(19) United States
(12) Patent Application Publication
(10) Pub. No.: US 2014/0111390 A1
(43) Pub. Date: Apr. 24, 2014

(54) COMPATIBILITY INTERFACE FOR OPERATING SYSTEM

(71) Applicants: Peter Alexander Carides, San Diego, CA (US); Barry R. Robbins, Carlsbad, CA (US)

(72) Inventors: Peter Alexander Carides, San Diego, CA (US); Barry R. Robbins, Carlsbad, CA (US)

(21) Appl. No.: 13/655,921

(22) Filed: Oct. 19, 2012

(51) Int. Cl. H01Q 1/28; G06K 19/077

(52) U.S. Cl. CPC H01Q 1/288; G06K 19/07773
USPC 343/705; 235/492; 29/601

(57) ABSTRACT

An on-board communication and navigation system for an aircraft is provided for allowing an aircraft to transmit and receive information via satellite link. Specifically, the system includes a radome assembly and a fuselage coupler. The radome assembly, for example, may include an antenna, an antenna control unit and an inertial reference unit. During installation, the fuselage coupler is securely and permanently mounted on the aircraft, typically on the fuselage at the top of the aircraft. Once the fuselage coupler is securely mounted, the radome assembly can be removably attached to the fuselage coupler, allowing the radome assembly to be quickly and easily removed and reattached to the aircraft, as needed.

### FIELD OF THE INVENTION

The present invention pertains generally to on-board satellite communication equipment for aircraft. More particularly, the present invention pertains to satellite communication systems in which a radome assembly is mounted on an airframe of an aircraft. The present invention is particularly, but not exclusively, useful as a system having a coupler for removably mounting a radome assembly on the fuselage of an airplane.

### BACKGROUND OF THE INVENTION

Aircraft, including commercial airplanes, are available in various shapes and sizes. Modernly, it is desirable to equip most, if not all of these aircraft, with a system which allows the aircraft to communicate with other network stations such as ground stations and/or other aircraft via satellite link. These systems can be useful for aircraft navigation, as well as other communication needs. For example, a typical on-board communication system may include one or more antenna(e) for transmitting and/or receiving signals from a satellite together with a radome to cover and protect the antenna(e). Typically, the system includes electronic hardware for amplifying and/or converting the transmit and receive signals and can include a software equipped computer processor for controlling and steering the antenna.

For functional reasons, the antenna and radome are positioned outside of the aircraft skin, and typically along the top of the aircraft, to allow the antenna to maintain line-of-sight communication with an orbiting satellite. With regard to the other communication system hardware described above, this equipment has typically been distributed throughout the aircraft, with some of the hardware located within or near the radome enclosure and some of the hardware located inside the aircraft. When outfitting an aircraft with such a system, a custom installation has typically been prescribed, at least insofar as a particular type of aircraft is concerned. This, of course, has caused these systems to be rather expensive and has complicated efforts to service or upgrade system components. Unfortunately, these custom installations have also reduced operational flexibility in that it has been difficult, if not impossible, to remove a radome assembly from one aircraft and install it on another.

As indicated above, the antenna/radome assembly is located external to the aircraft, and as a consequence, can affect the aerodynamic properties of the aircraft. More specifically, it is generally undesirable for the externally located radome to introduce drag forces or adversely affect the lift forces generated by the aircraft. These considerations have typically dictated that a custom assembly be employed that is designed to minimize any aerodynamic impact on the aircraft.

In addition to aerodynamic considerations, structural implications must be considered. As a minimum, through-holes must be established in the aircraft skin to pass cables between the radome assembly and the aircraft's interior. With this in mind, it is important that the redome assembly installation does not adversely affect the structural integrity of the aircraft or interfere with the ability of the aircraft to maintain adequate cabin pressure.

In light of the above, it is an object of the present invention to provide a system for quickly installing and removing a radome assembly from an aircraft. Still another object of the present invention is to provide a radome assembly installation that does not adversely affect the structural integrity or aerodynamic performance of an aircraft. Yet another object of the present invention is to provide a radome assembly and fuselage coupler which are easy to use, relatively simple to implement, and comparatively cost effective.

### SUMMARY OF THE INVENTION

In accordance with the present invention, an onboard communication and navigation system for an aircraft is provided for allowing an aircraft to transmit and receive information via satellite link. Specifically, the system includes a redome assembly and a fuselage coupler. The redome assembly, for example, may include an antenna, an antenna control unit and an inertial reference unit. During installation of the system, the fuselage coupler is securely and permanently mounted on the aircraft, typically on the aircraft's fuselage at the top of the aircraft. Once the fuselage coupler is securely mounted, the redome assembly can be attached to the fuselage coupler. For the present invention, a removable attachment is used to fasten the radome assembly to the fuselage coupler, allowing the radome assembly to be quickly and easily removed and reattached to the aircraft, as needed.

In greater structural detail, the fuselage coupler is formed with a smooth external surface to minimize aerodynamic drag and includes a first portion that is configured to establish a secure and permanent attachment to the fuselage of the aircraft. More specifically, the size and shape of the first fuselage coupler portion is designed to conform to the fuselage of a particular aircraft type at the installation location. The coupler is also formed with a second portion that is configured to establish a removable attachment with the radome assembly. As a consequence of this arrangement, two different types of aircraft may be fitted with differently sized and/or shaped fuselage couplers and yet be equipped with identical radome assembles.

The removable attachment between the fuselage coupler and radome assembly can be achieved, for example, using a plurality of sensor-monitored clamps. Alternatively, or in addition to the clamps, a mechanical interlock system can be provided at the interface between the fuselage coupler and the radome assembly. In one embodiment of the system, only power and data lines extend through the fuselage coupler from the radome assembly into the aircraft. For this embodiment, each electrical cable extending from the radome assembly to the fuselage coupler includes a cable disconnect to facilitate quick and easy installation and removal of the radome assembly.

In addition to the above described structure, the fuselage coupler may be further outfitted with memory storage for containing aircraft information along with electronic circuitry to allow the memory to be read using a radio-frequency identification (RFID) interrogator. Examples of aircraft information that can be stored in the fuselage coupler memory include the name of the airline operating the aircraft, the aircraft type (i.e. manufacture and model) and the aircraft serial number.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of an aircraft having a radome assembly and fuselage coupler;

FIG. 2 is an exploded, cross-sectional view showing a fuselage, radome assembly and fuselage coupler as seen along line 2-2 in FIG. 1;

FIG. 2A is a cross-sectional view as in FIG. 2 showing a fastening system for securely and permanently mounting a fuselage coupler onto a fuselage of an aircraft;

FIG. 2B is an exploded, cross-section view of a portion of the system as seen along line 2B-2B in FIG. 1 showing a mechanical interlock between a fuselage coupler and radome assembly;

FIG. 2C is a cross-section view of a portion of the system as seen along line 2B-2B in FIG. 1 showing the mechanical interlock of FIG. 2B after attachment of a fuselage coupler to a radome assembly;

FIG. 20 is a cross-section view of a portion of the system as in FIG. 2B showing a sensor monitored clamp for removably attaching a radome assembly to a fuselage coupler;

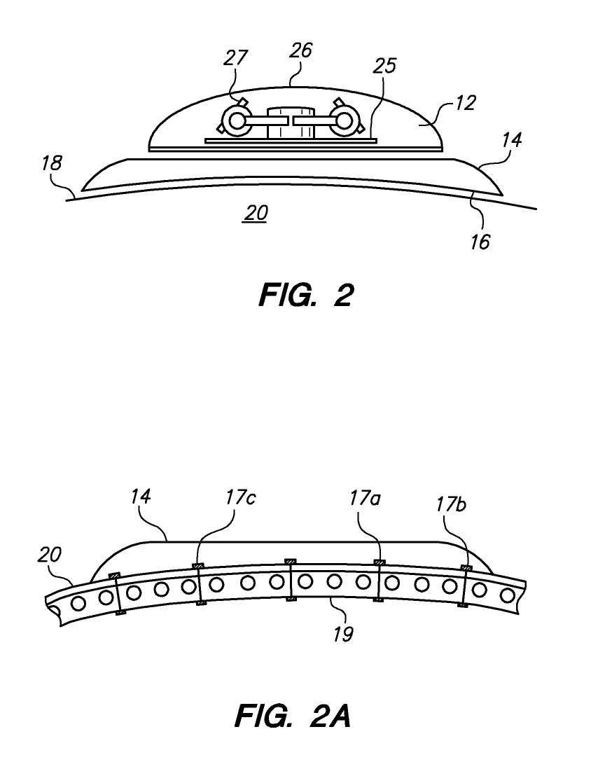

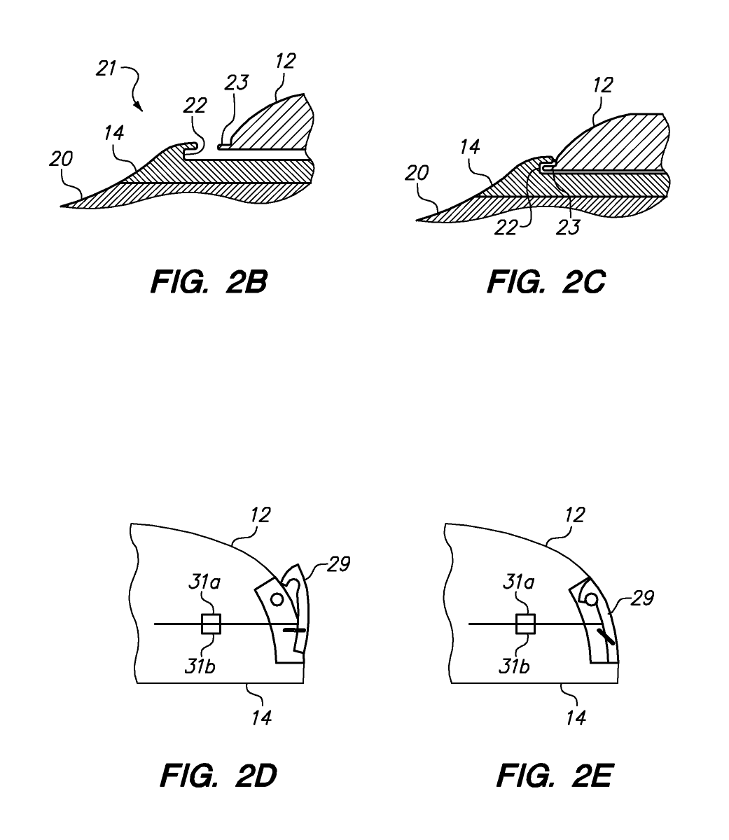

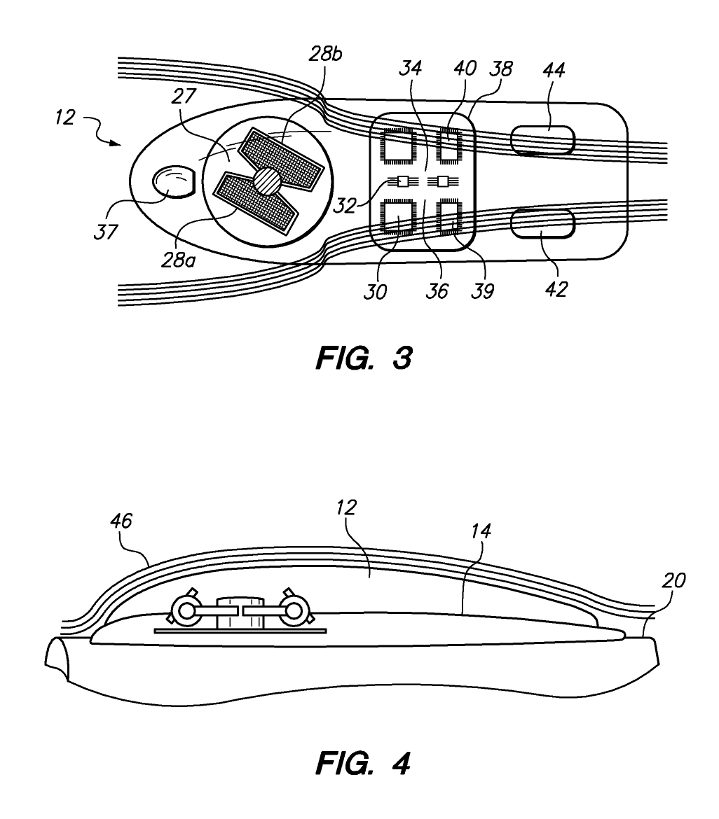

FIG. 2E is a cross-section view of the clamp shown in FIG. 2D shown after clamping a radome assembly to a fuselage coupler;

FIG. 3 is a top plan view of a radome assembly and fuselage coupler; and

FIG. 4 is a cross-section view as in FIG. 2B of the radome assembly and fuselage coupler.

### DESCRIPTION OF THE PREFERRED EMBODIMENTS

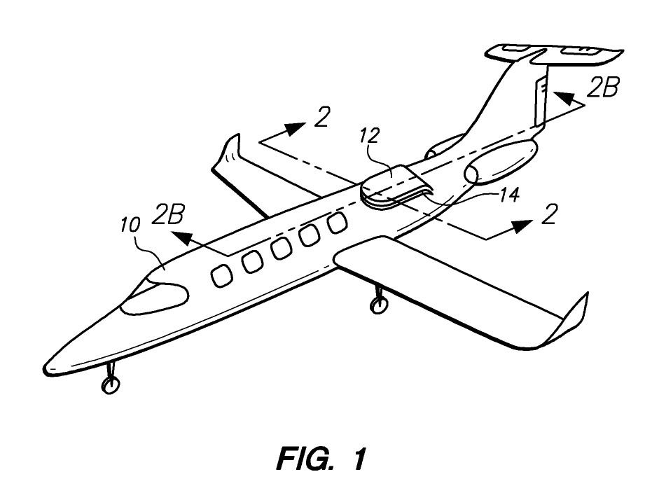

Referring initially to FIG. 1 an aircraft 10 is shown having an on-board communication and navigation system for transmitting and receiving information via satellite link (satellite not shown). As shown, the system includes a radome assembly 12 and a fuselage coupler 14 that are positioned along a top surface of the aircraft 10 to allow a line-of-sight communication path between the radome assembly and an orbiting satellite (not shown).

As shown in FIG. 2, the fuselage coupler 14 includes an interface portion 16 that is sized and shaped to conform to the outer surface 18 of the fuselage 20 of the aircraft 10. Typically, this involves designing the portion 16 of the fuselage coupler 14 to accommodate the width and curvature of the aircraft fuselage 20 for the specific type and size of aircraft 10. As shown in FIG. 2A, the fuselage coupler 14 is securely and permanently mounted on the fuselage 20, for example, using a plurality of bolts (bolts 17a-c labeled) which extend through the skin of the fuselage and into or through a structural member such as a fuselage rib 19. Typically, the bolt placement/pattern for holding the bottom surface of the fuselage coupler 14 against the skin of the fuselage 20 is flexible and/or may be designed for a particular type/model of fuselage 20. Specifically, the bolt pattern must accommodate the fuselage 20. On this point, the bottom surface and bolts pattern of the fuselage coupler 14 will need to conform with the manufacturer's specifications for the fuselage 20. Also, the bolt placement from the fuselage coupler 14 must fasten the fuselage coupler 14 into substantial portions of the rib(s) 19, which typically include holes to minimize weight, as shown.

Use of a permanent mount to attach the fuselage coupler 14 to the aircraft 10 can result in a structurally stronger, less complicated mounting arrangement as compared with an arrangement that is designed to allow subsequent and/or periodic removal of a component from the fuselage skin.

Once the fuselage coupler 14 is securely mounted on the aircraft 10, the radome assembly 12 can be attached to the fuselage coupler 14. To allow the radome assembly 12 to be quickly and easily removed and reattached to the aircraft 10, a removable attachment is used to fasten the radome assembly 12 to the fuselage coupler 14. In one implementation, the removable attachment is designed such that the radome assembly 12 may be removed from and thereafter reattached to the fuselage coupler 14 within about twenty minutes. For example, as shown in FIGS. 2B and 2C, the removable attachment between the fuselage coupler 14 and radome assembly 12 can include a mechanical interlock 21. More specifically, the mechanical interlock 21 is typically used at the forward or leading edge of the fuselage coupler 14 where it is important to ensure that a smooth aerodynamic transition is provided between the fuselage coupler 14 and radome assemble 12. As shown, the mechanical interlock 21 can include a keyway 22 that is formed on an inner surface of the fuselage coupler 14 and a corresponding lip 23 that is formed on the forward edge of the radome assembly 12. As shown in FIG. 2C, lip 23 engages with the keyway 22 of the fuselage coupler 14 to attach the fuselage coupler 14 and radome assembly 12.

Alternatively, or in addition to the mechanical interlock 21 described above, the removable attachment between the fuselage coupler 14 and radome assembly 12 can include one or more clamps 29, as shown in FIGS. 2D and 2E. Typically, the clamps 29 are positioned to engage an outside surface of the radome assembly 12 as shown and are located on the sides and/or trailing edge of the radome assembly 12. For example, the clamps 29 can be recessed in the radome assembly 12 and fuselage coupler 14 to provide an aerodynamically smooth surface, as shown in FIG. 2E. In one embodiment, the lip 23/keyway 22 interlock is used on the leading edge of the radome assembly 12 and one or more clamps 29 are employed on the sides/trailing edge to engage to hold the radome assembly 12 on the fuselage coupler 14 when the lip 23 of the radome assembly 12 is engaged with the keyway 22 of the fuselage coupler 14.

As shown in FIGS. 2D and 2E, one or more sensors 31a,b can be included to provide an electronic indication of the seal/engagement between the fuselage coupler 14 and radome assembly 12. Alternatively, the sensors 31a,b can be positioned on the clamps 29 or located internally within the fuselage coupler 14 and radome assembly 12.

With the sensors 31a,b, an engagement of the fuselage coupler 14 with the radome assembly 12 can be electronically logged. Specifically, sensors 31a,b associated with the clamps 29 can give an electronic verification of the engagement. Further, serial numbers for both the fuselage coupler 14 and radome assembly 12 can be logged and subsequently tracked during their operational histories for management purposes.

In one implementation, illustrated in FIG. 3, the radome assembly 12 may include all components necessary to transmit and receive signals to and from a satellite and convert the signals into a form for communication with other station(s) that are connected to a local area network (LAN) such as an Ethernet LAN. In this implementation, only power cables and LAN cables (e.g. Ethernet cables) are required to pass through the fuselage coupler 14 from the radome assembly 12 and into the aircraft 10 (see FIG. 1). FIG. 3 shows the components of an exemplary radome assembly 12 in which the components of the radome assembly 12 are arranged in modules to facilitate component upgrade and repair.

As further shown in FIGS. 2 and 3, the radome assembly 12 can include a base 25, internal components mounted on the base 25, and a radome shell 26 that attaches to the base 25 and covers the internal components. The radome shell 26 can be made of a material known in the pertinent art that is RF transparent throughout the frequency ranges of cellular, 802.11 (WiFi), Bluetooth, GPS and the Ku & Ka bands. As further shown, the internal components can include an antenna system 27 mounted on the base 25. The antenna system 27 can be any type known in the pertinent art for sending and receiving signals from a satellite such as a parabolic dish or the multi-panel phased array antenna shown in FIGS. 2-4. For the embodiment shown in FIGS. 2-4, a phased array antenna having two panels 28a,b is employed. For example, the phased array antenna system can provide a multi-band capability such as a dual band (Ku/Ka) antenna system. As best seen in FIG. 3, the radome assembly 12 can also include electronic equipment such as an antenna control unit 30 for electronically and/or mechanically steering the antenna and/or configuring the antenna for the selected band, etc. Other electronic components in the radome assembly 12 can include one or more inertial reference units 32, for example, having integrated GPS, modem(s) 34 such as a Dual VSAT communications and/or iridium modern(s), an RF chain module 36 having amplifiers and convertors (e.g. block up converter (BUC), low noise block down converter (LNB), amplifiers (HPA/SSPA), waveguide, etc.), video-camera 37, a secure 802.11 wireless access module 38 (having, for example, 4G-LTE, Bluetooth & GPS antenna capabilities) and/or power supply units (PSU) 39. Typically, whenever practical, the electronics associated with the radome assembly 12 are located in the radome assembly 12. Also, it is preferable that all RF devices be as close to the antenna system 27 as practical to minimize losses.

Continuing with reference to FIG. 3, the radome assembly 12 can also include a central processing unit 40 and associated software and memory (e.g. main memory and secondary memory such as one or more solid state drive arrays (SSDA)) that are operationally connected to one or more of the above-described electronic components via power, sensor and data busses. Together, these radome assembly 12 components cooperate to transmit and receive signals to and from a satellite (not shown) and convert the signals into a form for communication with one or more station(s) (not shown) inside the aircraft 10 that are connected to a local area network. The signals can be encoded with voice transmissions, data including navigational information and/or flight sensor information, etc. In one embodiment of the system, only power and data lines (not shown) extend through the fuselage coupler 14 from the radome assembly 12 into the aircraft 10. In one implementation, the data lines emanating from the radome assembly 12 consist solely of Ethernet and L-Band data lines. For this embodiment, each electrical cable extending from the radome assembly 12 to the fuselage coupler 14 includes a cable disconnect (not shown) to facilitate quick and easy installation and removal of the redome assembly 12 from the aircraft 10.

FIG. 3 further shows that in addition to the above described structure, the redome assembly 12 may be further outfitted with memory storage 42 for containing aircraft information along with electronic circuitry 44 to allow the memory storage 42 to be read using an RFID interrogator (not shown). For example, the memory storage 42 can include embedded, intelligent flash memory. With this arrangement, aircraft information can be read with the radome assembly 12 installed or removed. Examples of aircraft information that can be stored in the memory storage 42 can include, but is not necessarily limited, to the name of the airline operating the aircraft, the aircraft type (i.e. manufacture and model), and the aircraft serial number.

FIG. 4 shows the radome assembly 12 and fuselage coupler 14 and shows flow lines 46 representing air moving past the radome assembly 12 and fuselage coupler 14. As seen there, the fuselage coupler 14 and radome assembly 12 can be formed with smooth external surfaces to minimize aerodynamic drag. In addition, FIG. 4 shows that the fuselage coupler 14 can act as a fender, deflecting laminar airflow up and away from seams, over and along top of radome assembly 12. With this arrangement, the fuselage coupler 14 and radome assembly 12 is designed to minimize induced drag, parasite drag and turbulent airflow. The design is also optimized to introduce opposing forces which maximize lift and laminar airflow.

While the particular Compatibility Interface for Operating System as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A system for establishing an information link between a satellite and an aircraft, the system comprising:
a fuselage coupler formed with a first portion configured to establish a secure and permanent attachment to the fuselage of the aircraft; and
a radome assembly having an antenna for transmitting signals to and for receiving signals from the satellite and a radome at least partially covering the antenna, the radome assembly being removably attached to the fuselage coupler.

2. A system as recited in claim 1 wherein the radome assembly further includes an antenna control unit and an inertial reference unit.

3. A system as recited in claim 1 wherein the fuselage coupler further includes memory storage for containing aircraft information and a circuit allowing said memory to be read using an RFID interrogator.

4. A system as recited in claim 3 wherein the aircraft information includes aircraft information selected from the group of aircraft information consisting of airline, aircraft type and aircraft serial number.

5. A system as recited in claim 1 wherein the fuselage coupler is formed with a smooth external surface to minimize aerodynamic drag.

6. A system as recited in claim 1 wherein a mechanical lock is provided to removably attach the radome assembly to the fuselage coupler.

7. A system as recited in claim 1 wherein a plurality of sensor monitored clamps are provided to removably attach the radome assembly to the fuselage coupler.

8. A system as recited in claim 1 wherein each electrical cable extending from the radome assembly to the fuselage coupler includes a cable disconnect.

9. A system for establishing an information link between a satellite and an aircraft, the system comprising:
a fuselage coupler;
a radome assembly having an antenna for transmitting signals to and receiving signals from the satellite and a radome at least partially covering the antenna;
a means for permanently attaching the fuselage coupler to the fuselage of the aircraft; and
a means for removably attaching the radome assembly to the fuselage coupler.

10. A system as recited in claim 9 wherein the radome assembly further includes an antenna control unit and an inertial reference unit.

11. A system as recited in claim 9 wherein the fuselage coupler further includes memory storage for containing aircraft information and a circuit allowing said memory to be read using an RFID interrogator.

12. A system as recited in claim 11 wherein the aircraft information includes aircraft information selected from the group of aircraft information consisting of airline, aircraft type and aircraft serial number.

13. A system as recited in claim 9 wherein the fuselage coupler is formed with a smooth external surface to minimize aerodynamic drag.

14. A system as recited in claim 9 wherein a mechanical lock is provided to removably attach the radome assembly to the fuselage coupler.

15. A system as recited in claim 9 wherein a plurality of sensor monitored clamps are provided to removably attach the radome assembly to the fuselage coupler.

16. A system as recited in claim 9 wherein each electrical cable extending from the radome assembly to the fuselage coupler includes a cable disconnect.

17. A method for installing a communications system to the exterior of an aircraft, the method comprising the steps of:
providing a fuselage coupler;
providing a radome assembly having an antenna for transmitting signals to and receiving signals from the satellite and a radome at least partially covering the antenna;
permanently attaching the fuselage coupler to the fuselage of the aircraft; and
removably attaching the radome assembly to the fuselage coupler.

18. A method as recited in claim 17 wherein the fuselage coupler is formed with a smooth external surface to minimize aerodynamic drag.

19. A method as recited in claim 17 wherein said removably attaching step is accomplished with a mechanical interlock.

20. A method as recited in claim 17 wherein said removably attaching step is accomplished with a plurality of sensor monitored clamps.
